(19) United States
(12) Patent Application Publication
(10) Pub. No.: US 2012/0195731 A1
(43) Pub. Date: Aug. 2, 2012

(54) DEVICE AND PROCESS FOR HANDLING COVERSLIPS FOR MICROSCOPE SLIDES

(75) Inventor: Joachim HOFFMANN, Lorsch (DE)

(73) Assignee: Leica Biosystems Nussloch GmbH, Nussloch (DE)

(21) Appl. No.: 13/354,375

(22) Filed: Jan. 20, 2012

(30) Foreign Application Priority Data
Jan. 31, 2011 (DE) 102011003375.0-56

(51) Int. Cl. B65G 47/91; B66C 1/02; B66C 1/10

(52) U.S. Cl. 414/752.1; 294/86.4; 294/183

(57) ABSTRACT

The invention relates to a coverslip handling device (100) comprising a pick-up component (200) for picking up a coverslip (800) and a sensor device (203, 204) for checking the state of the coverslip (800) picked up, the coverslip handling device (100) being arranged to pick up a coverslip (800) automatically by means of the pick-up component (200), to check the state of the coverslip (800) picked up by means of the sensor device (203, 204) so that unusable coverslips are detected, and to set down a coverslip (800) that has been detected as being usable, automatically by means of the pick-up component (200) on a slide (500) provided for this purpose, wherein the coverslip handling device (100) is configured to automatically discard a coverslip found to be unusable by means of the pick-up component (200).

### CROSS REFERENCE TO RELATED APPLICATIONS

This application claims priority of German patent application number 10 2011 003 375.0 filed Jan. 31, 2011, the entire disclosure of which is incorporated by reference herein.

### FIELD OF THE INVENTION

The present invention relates to a device and a process for handling coverslips for microscope slides.

### BACKGROUND OF THE INVENTION

In histology, covering machines (coverslippers) are used to cover slides on which for example tissue sections are located. It is known for this purpose to apply metered amounts of a cover medium (a kind of liquid adhesive) to the slide and then to press a coverslip onto it to form a seal. Such a coverslipper is marketed by the applicant, for example, under the name “Leica CV5030”.

A process and a device of the generic kind are known from DE 101 44 048 A1. In coverslip handling devices and methods of this kind the taking of the coverslip from a supply and the application of the coverslip to a slide in order to cover a specimen are carried out by one and the same pick-up element. However, this pick-up element is relatively cumbersome and there is scope for improvement in the handling operation in the event of breakage of the glass.

### SUMMARY OF THE INVENTION

The invention provides a possible method of improving the handling of coverslips, particularly in coverslippers, so that unusable, especially broken, coverslips are automatically detected and automatically discarded as well. They are automatically removed from the processing cycle. There is no longer any need for the user to intervene manually. The processing speed and hence also the cost/benefit ratio are significantly improved. In the prior art, broken glass had to be laboriously removed from the equipment, with some considerable risk of injury. These disadvantages are overcome.

For automatically picking up the coverslip and depositing it on the microscope slide provided for this purpose and for the sorting process, the invention uses one and the same pick-up component. The component costs therefore remain low.

The pick-up component can expediently be positioned in three different operating positions for the automatic pick-up, set-down and optionally rejection of a coverslip, namely a first operating position for the setting down the coverslip, a second operating position for the picking up of the coverslip and a third operating position for the rejection of the coverslip. However, it is also possible for the slide which is to be covered, the supply of coverslips and/or a disposal container to be positioned within the range of operation of the pick-up component, so that the pick-up component can be positioned in one, two or three operating positions.

If the pick-up component is moved along a guide rail, one drive unit is sufficient to bring about this movement of the pick-up component. This embodiment is very stable, requires few components but still allows satisfactory handling of the coverslips. By suitable shaping of the guide rail a predetermined movement in two or three directions, for example, may also be executed using a single drive unit.

If a coverslip is detected as being unusable, there is some probability that there may be splinters of glass, for example, on the next coverslip in the supply. According to an advantageous embodiment, it is envisaged that at least one coverslip that follows a coverslip detected as being unusable is also automatically discarded.

The pick-up component expediently comprises at least two pick-up units, so that a coverslip is held by the pick-up component at at least two points. This improves the grip. A particularly simple picking up and setting down operation is possible if the pick-up units are configured as suction units, so that a coverslip that is to be picked up can be picked up by evacuating the suction units and set down by venting the suction units. Expediently, the pick-up units are configured so as to be compressed during the picking up operation.

Advantageously, the pick-up component comprises a counterpressure element arranged between the two pick-up units. If the pick-up units are of flexible construction, a certain flexing of the picked up coverslip can simultaneously be achieved during the pick-up. Setting down is also made easier, as the guiding of the pick-up units leads to a controlled setting down of the coverslip without any bubbles being formed.

In a preferred embodiment, a flexible, e.g. spring-loaded, counterpressure element projects over a plane spanned by the pick-up units, so that having been picked-up a coverslip is pressed against the counterpressure element and at the same time flexed slightly. This makes it easier both to pick up a single coverslip and also to set it down in bubble-free manner on a microscope slide provided for this purpose and prepared with a suitable adhesive. This embodiment is also very stable and requires few components while still allowing satisfactory handling of the coverslips.

During picking up, the pick-up units are preferably brought close to the coverslip while the counterpressure element yields. When contact is made the coverslip is securely held and raised at its ends by the pick-up units which are compressed during the pick-up. Then the pick-up component is raised. As a result the counterpressure element relaxes and the coverslip is curved in the desired manner. For setting it down, the coverslip is moved towards the slide until it makes contact. It is set down by opening, particularly venting, the pick-up units, causing them to decompress and enabling the coverslip to return to its flat shape. This can be assisted by pressing down while the counterpressure element yields. However, there is no need to press or roll the coverslip on and the drives that would otherwise be necessary to do this can be dispensed with.

The coverslip handling device is equipped with a sensor device for monitoring the state of a coverslip that has been picked up. This sensor device expediently has at least one first sensor which sends a corresponding signal when a usable coverslip is correctly picked up by the pick-up component. The sensor may be, for example, an optical sensor, a contact sensor or preferably a magnetic sensor (e.g. a Hall-effect sensor).

Most preferably, the counterpressure element comprises a first sensor of the sensor device. Thus the function of the sensor and of the counterpressure element can advantageously be combined, leading to a saving on components.

In an advantageous embodiment the sensor device comprises at least one second sensor for detecting a coverslip adhering to the coverslip that has been picked up. Two or more coverslips picked up are detected as unusable and rejected.

Further advantages and embodiments of the invention will become apparent from the description and the accompanying drawings.

It will be understood that the features mentioned above and those still to be described hereinafter may be used not only in the particular combination specified but also in other combinations or on their own without departing from the scope of the present invention.

### BRIEF DESCRIPTION OF THE DRAWINGS

The invention is schematically illustrated in the drawings by means of an embodiment by way of example and is described in detail hereinafter with reference to the drawings, in which:

FIG. 1 schematically shows a preferred embodiment of a coverslip handling device according to the invention in a first operating position for depositing a coverslip;

FIG. 2 shows the coverslip handling device according to FIG. 1 in a second operating position for picking up a coverslip;

FIG. 3 shows the coverslip handling device according to FIG. 1 in a third operating position for rejecting or discarding a coverslip; and

FIG. 4 shows a preferred embodiment of a coverslipper according to the invention.

### DETAILED DESCRIPTION OF THE INVENTION

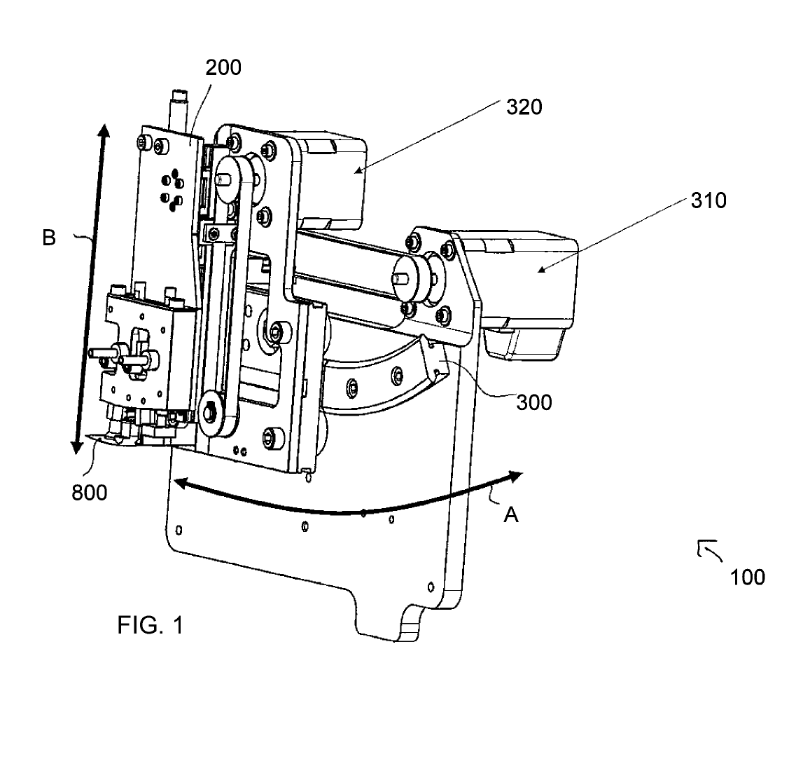

FIGS. 1 to 4 are described substantially cohesively and comprehensively, while identical elements have been given the same reference numerals.

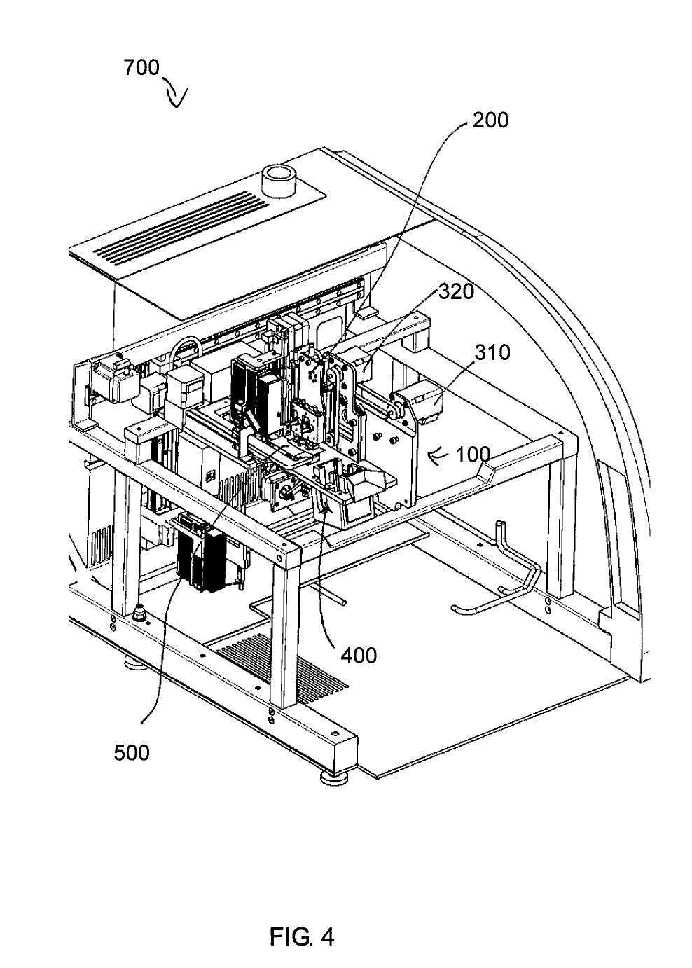

FIGS. 1 to 3 show a preferred embodiment 100 of a coverslip handling device according to the invention in different operating positions. A coverslipper according to FIG. 4 which is equipped with the coverslip handling device 100 is designated 700.

The coverslip handling device 100 comprises a pick-up component 200 which is mounted so as to be movable along a guide rail 300 in direction A along the coverslip handling device 100. A first drive 310 is provided for movement in direction A along the guide rail 300. The pick-up component 200 is also mounted to be movable in a direction B, while a second drive 320 is provided for movement in direction B.

The pick-up component 200 comprises two pick-up units which in this case are in the form of suction units 201 and 202 for picking up a coverslip 800. The pick-up component 200 also comprises a counterpressure element 203 which in this case simultaneously acts as a sensor.

The coverslip handling device 100 is also provided with a disposal container holder 600 into which suitable disposal containers can be inserted into which coverslips detected to be unusable are discarded.

The movement of the pick-up component 200 in direction A serves to bring the pick-up component into the different operating positions for setting down, picking up and discarding a coverslip. The movement in direction B serves to move the pick-up component 200 into and out of a coverslip magazine 400 in order to be able to pick up a new coverslip. Moreover, the movement in direction B serves to deposit a coverslip that has been picked up on a slide 500 provided for this purpose.

Fresh coverslips are stored in the coverslip magazine 400. The magazine 400 is configured so that the coverslips are placed in the magazine in the form of a stack. The magazine is tilted relative to the horizontal, so that the left hand side wall 401 in the Figures forms a defined stop for the coverslips stored therein. This has the advantage that irrespective of their length coverslips will always be positioned towards the front edge when placed on the microscope slide 500.

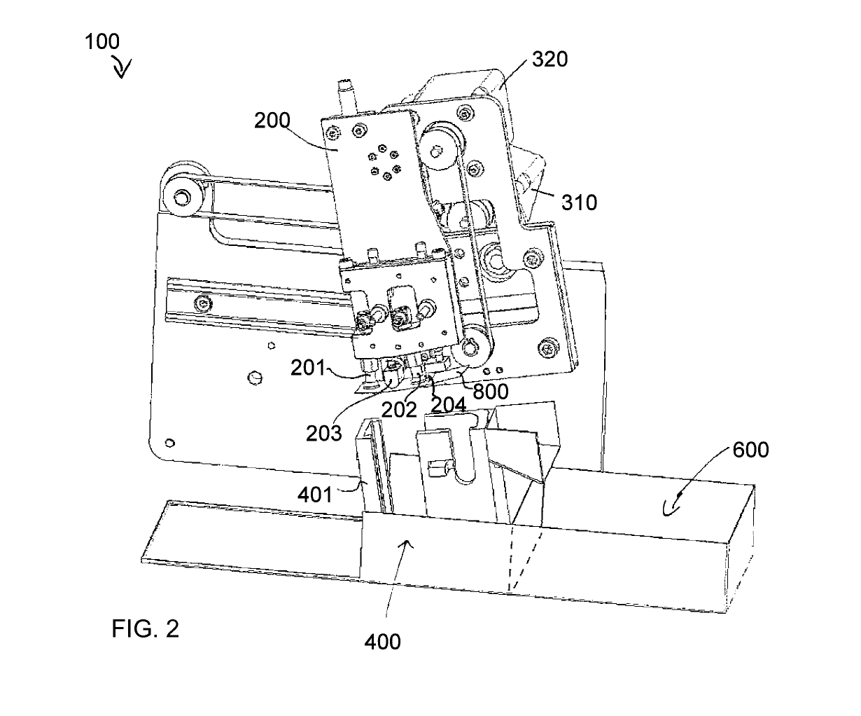

In order to take out a new coverslip the pick-up component 200 is moved into the second operating position according to FIG. 2 along the guide rail 300. The curved shape of the guide rail simultaneously causes the pick-up component 200 to move into a tilted position which, in the second operating position, corresponds to the inclined position of the coverslip magazine 400. Then the pick-up component 200 is moved into the coverslip magazine until the sensor 203 is contacted by a coverslip located in the magazine 400.

The sensor is of flexible construction, the movement being stopped when the sensor is pressed in to the level of the suction units 201 and 202. The coverslip is then picked up by means of the suction units 201, 202. The suction units 201, 202 are evacuated and are slightly compressed at the same time. For this purpose, sections of them are in the form of a bellows, for example. When the pick-up component 200 is moved out of the coverslip magazine 400, the spring-loaded sensor 203 generates pressure on the coverslip 800 that has been picked up and which consequently bends slightly. If the coverslip is unusable, for example broken, this leads to a position of the sensor 203 which is untypical for a picked-up coverslip, for example because the sensor returns to its resting position, and is detected accordingly.

Moreover, a second sensor 204 is provided which is contacted by a correctly curved coverslip 800 that has been picked up. If a usable coverslip is picked up correctly, this leads to a typical composition of the signals of the two sensors 203 and 204. However, if the coverslip is unusable, for example if it is broken or if a number of coverslips are adhering to one another, this results in an untypical signal composition for the two sensor signals. This state is recognised as a fault.

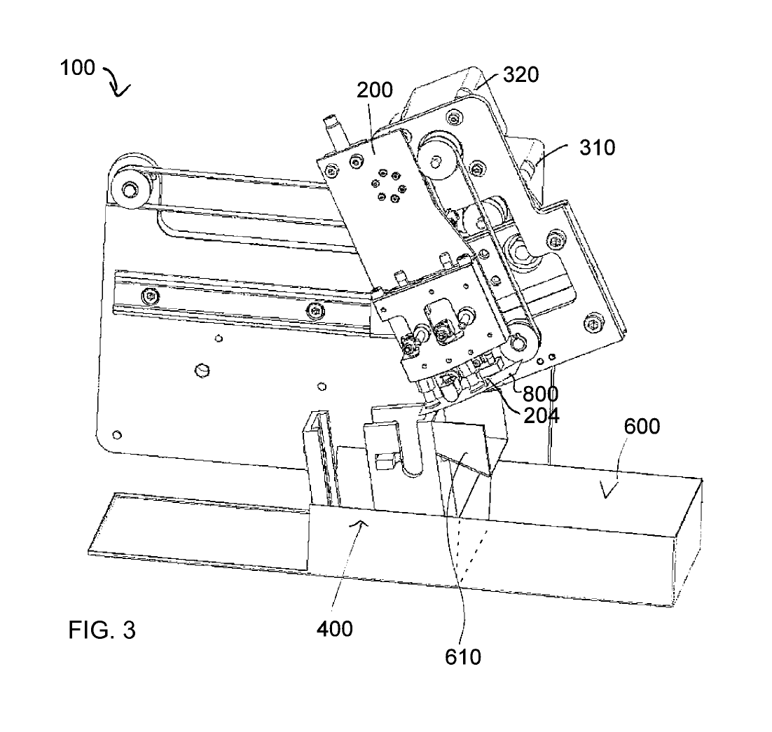

Subsequently, the pick-up component 200 is moved into the third operating position for discarding or rejecting unusable coverslips as shown in FIG. 3. The curved shape of the guide rail 300 leads to further inclined position of the pick-up component 200, allowing the picked up coverslip 800 to be discarded more easily.

When the pick-up component 200 has reached the third operating position above the disposal container holder 600, the suction units 201, 202 are vented and the unusable coverslip is discarded. To simplify disposal into a disposal container provided in the disposal container holder, a rejection hopper 610 is provided to act as a guide. Because of the possibility of splinters of glass being located on the coverslip which is next in the coverslip magazine, when an unusable cover slip is detected the following coverslip is also automatically discarded in this way.

For ease of disposal, a waste bin, particularly a disposable product, may be inserted in the disposal container holder. A waste bin is provided underneath the coverslipping station. This may be lined with metal foil, for example, and thus provides sufficient resistance for holding residues of the coverslipping medium (e.g. from the priming process) and fragments of glass (from coverslips that have been detected or discarded). For disposal the bin can be taken out, closed off with a lid and then taken away safely. The waste bin could simultaneously serve as the delivery package for coverslips. In this case the coverslips are taken out of the package and placed or intermediately stored in the magazine 400, for example. The package can then be inserted in the disposal container holder as a waste bin and then used later for safe disposal. The quantity of coverslips that can be sent in a package solution of this kind could correspond roughly to the number required between the changeover times for the waste bins. Configuring the disposal container as a package and waste bin provides a double benefit.

If the coverslip has been detected as being usable, the pick-up component 200 is moved along the guide rail 300 into the first operating position according to FIG. 1, so that the coverslip 800 that has been picked up is arranged above a microscope slide 500 that is to be covered. The coverslip is then set down by the movement of the pick-up component in direction B. As a result of the slight preliminary flexing of the coverslip, its centre is first to be dipped into the coverslip medium as it is set down on the slide. As soon as the suction units are vented, they decompress, the coverslip straightens out and automatically displaces the covering medium. There is no need to press or roll the coverslip on and the drives that would otherwise be needed for this can be dispensed with.

The invention provides a possible method of picking up coverslips of different sizes from a magazine, checking them for quality, in the event of a fault discarding them into a waste area, but otherwise placing them accurately on the slide. Any discarded coverslips can be safely stored and disposed of.

The invention is not to be limited to the specific embodiments disclosed, and modifications and other embodiments are intended to be included within the scope of the invention.

What is claimed is:

1. A coverslip handling device (100), comprising:
a pick-up component (200) arranged to pick up a coverslip (800) automatically; and
a sensor device (203, 204) for detecting a state of the coverslip (800) picked up by the pick-up component (200), the state indicating a usable coverslip or an unusable coverslip;
wherein the pick-up component (200) is configured to automatically set down a detected usable coverslip (800) on a slide (500);
wherein the pick-up component (200) is configured to automatically discard a detected unusable coverslip (800).

2. The coverslip handling device (100) according to claim 1, wherein the pick-up component (200) comprises two pick-up units (201, 202) for picking up and holding the coverslip (800).

3. The coverslip handling device (100) according to claim 2, wherein the two pick-up units (201, 202) are suction units that pick up the coverslip (800) by evacuating the suction units, and set down the coverslip (800) by venting the suction units.

4. The coverslip handling device (100) according to claim 2, wherein the pick-up component (200) comprises a counterpressure element (203) disposed between the two pick-up units (201, 202).

5. The coverslip handling device (100) according to claim 4, wherein one or more of the following are flexible: the counterpressure element (203) and the two pick-up units (201, 202).

6. The coverslip handling device (100) according to claim 4, wherein the counterpressure element (203) comprises at least one first sensor of the sensor device.

7. The coverslip handling device (100) according to claim 6, wherein the sensor device (203, 204) comprises at least one second sensor (204) for detecting an additional coverslip adhered to a picked-up coverslip (800).

8. The coverslip handling device (100) according to claim 1, further comprising a guide rail (300), wherein the pick-up component (200) is movable along the guide rail (300) into different operating positions.

9. The coverslip handling device (100) according to claim 8, wherein the pick-up component (200) is configured to be positioned in a first operating position for picking up the coverslip, in a second operating position for setting down the coverslip and in a third operating position for discarding the coverslip.

10. The coverslip handling device (100) according to claim 1, further comprising a holder (600) for receiving a replaceable disposal container into which one or more unusable coverslips are discarded.

11. The coverslip handling device (100) according to claim 1, wherein the pick-up component (200) is arranged to automatically discard a subsequent coverslip that follows a detected unusable coverslip (800).

12. A coverslipper having a coverslip handling device (100) according to claim 1.

13. A process for automatically handling coverslips, comprising the steps of:
picking up a coverslip (800) with a coverslip handling device;
detecting a state of the coverslip (800) with the coverslip handling device, the state indicating a usuable coverslip or an unusable coverslip; and
discarding a detected unusable coverslip (800) automatically with the coverslip handling device.

14. The process according to claim 13, wherein the coverslip handling device comprises:
a pick-up component (200) arranged to pick up a coverslip (800) automatically; and
a sensor device (203, 204) for detecting the state of the coverslip (800) picked up by the pick-up component (200);
wherein the pick-up component (200) is configured to automatically set down a detected usable coverslip (800) on a slide (500);
wherein the pick-up component (200) is configured to automatically discard a detected unusable coverslip (800).
